(19) United States
(12) Patent Application Publication
(10) Pub. No.: US 2010/0310078 A1
(43) Pub. Date: Dec. 9, 2010

(54) SYSTEM FOR USER-CENTRIC IDENTITY MANAGEMENT AND METHOD THEREOF

(75) Inventors: Seung-Hyun KIM, Daejeon (KR); Deok-Jin KIM, Daejeon (KR); Soo-Hyung KIM, Daejeon (KR); Kwan-Soo JUNG, Daejeon (KR); Sang-Rae CHO, Daejeon (KR); Jin-Man CHO, Daejeon (KR); Dae-Seon CHOI, Daejeon (KR); Young-Seob CHO, Daejeon (KR); Jong-Hyouk NOH, Daejeon (KR); Seung-Hun JIN, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/791,764

(22) Filed: Jun. 1, 2010

(30) Foreign Application Priority Data
Jun. 3, 2009 (KR) 10-2009-0049181

(51) Int. Cl. H04L 9/22; G06F 15/16; H04L 9/30

(52) U.S. Cl. 380/282; 709/229; 709/228; 380/44

(57) ABSTRACT

A user terminal for a user-centric identity management system includes: a browser that requests a service to the service provider server and receives a service parameter in which a plurality of selectable protocol parameters corresponding to the service are recorded from the service provider server; an interaction unit that selects any one protocol parameter among the plurality of protocol parameters by receiving the service parameter through the browser; and a service processing unit that performs a service protocol with the service provider server on the basis of the protocol parameter selected through the interaction unit, and receives token information required to receive the service from the service provider server and transfers the token information to the browser.

### RELATED APPLICATIONS

The present application claims priority to Korean Patent Application Serial Number 10-2009-0049181, filed on Jun. 3, 2009, the entirety of which is hereby incorporated by reference.

### BACKGROUND OF THE INVENTION

1. Field of the invention

The present invention relates to a system for user-centric identity management and a method thereof. More particularly, the present invention relates to a system for user-centric identity management providing a service required for user identity management under an identity management environment with various intensities and a method thereof.

2. Description of the Related Art

In a present Internet environment, it is inconvenient due to different identification methods and personal information input methods for each site and leakage of personal information is severe due to a phishing attack, etc., such the current Internet environment is weak in convenience and security. Further, most of sites are requiring more information than necessary to provide an Internet service. For example, users should provide their own important personal information such as a name, a resident registration number, an address, a phone number, an e-mail address, etc. at the time of subscribing to a site in order to use the Internet service. However, the current Internet environment has a problem in that all rights for controlling personal information are transferred to a service provider only by comprehensively agreeing to the provisions and rules at the time of subscribing to the Internet site, such that a user's own control right for the personal information becomes void.

Further, since the users subscribe to too many sites, it is not easy for the users to memorize sites to which they provide their own personal information and contents of information which they provide. In addition, many small sites do not completely consider matters in regards to protecting information and privacy protection problems while managing customer information. Moreover, the sites may illegally sell the personal information.

Therefore, a countermeasure is required, which can reduce infringement of the personal information due to abuse of the personal information by providing an intuitive and consistent identification method and strengthening the user's own control right.

In order to solve the above-mentioned problems, technologies for safely managing and sharing the user's personal information are being proposed. A representative example of the technology includes a user-centric ID management system. The user-centric ID management system has an object to provide an environment in which the user is positioned at the center of all transactions to control the circulation flow of his/her own personal information so as to more conveniently and safely manage his/her personal information at the time of using the Internet.

Unlike the existing ID management system managed primarily by the service provider providing the Internet service, in the user-centric ID management system, the user can possess or manage the personal information in person or directly control personal information which the service provider possesses. Therefore, since the user can have a control right for the user's personal information and since the user expose desired personal information at a desired timing, it is possible to strengthen personal privacy.

However, the existing user-centric ID management system does not consider a service other than a simple identification service. Further, the existing user-centric ID management system does not consider a detailed identification mechanism even for the identification service.

Therefore, it is assessed that a technology used in the existing user-centric ID management system is not suitable in an environment requiring comparatively high-level security.

In order to solve the problem, a predetermined identification technology having a high security level may be used. Although, the predetermined identification technology is not suitable because of the characteristic of the user-centric ID management system that needs to consider various services and terminals. Besides, the existing user-centric ID management system considers only a protocol for the identification service, but does not consider other service protocols.

That is, the existing user-centric ID management system does not consider a method in which the user can centrically control the circulation flow of the user's personal information with various security levels with respect to services such as identification, subscription, update of identification information, submission and update of a basic profile, log-out, secession, etc.

### SUMMARY OF THE INVENTION

The present invention is contrived to solve the problem and an object of the present invention is to provide an identity management system and a management method thereof in which a user can centrically control the circulation flow of user's personal information with various security levels with respect to services such as identification, subscription, update of identification information, submission and update of a basic profile, log-out, secession, etc. under a user-centric ID management environment.

A user terminal for a user-centric identity management system according to an embodiment of the present invention includes: a browser that requests a service to the service provider server and receives a service parameter in which a plurality of selectable protocol parameters corresponding to the service are recorded from the service provider server; an interaction unit that selects any one protocol parameter among the plurality of protocol parameters by receiving the service parameter through the browser; and a service processing unit that performs a service protocol with the service provider server on the basis of the protocol parameter selected through the interaction unit, and receives token information required to receive the service from the service provider server and transfers the token information to the browser.

In particular, the service parameter is any one of service parameters for site subscription, identification, update of identification information, update of a profile, log-out, and site secession for site subscription, identification, update of identification information, update of a profile, log-out, and site secession.

Further, the interaction unit outputs the plurality of selectable protocol parameters to a user and selects any one protocol parameter among the plurality protocol parameters by receiving the resulting user selection.

Further, the protocol parameter is a protocol parameter relating to any one of an identification type, an encoding type, and a key size for encoding.

Further, the identification type includes at least one identification type of a password, a public key infrastructure (PKI), bio-information, and a two-factor identification type.

Further, the service processing unit includes an encoding portion that encodes information required to perform the service protocol with the service provider server on the basis of the selected protocol parameter.

Further, the user terminal further includes a server validation portion that establishes a communication channel with the service provider server in accordance with server validation recorded in the service parameter and validates the service provider server.

Further, in the service parameter, location identification information of the service provider server, a domain name of the service provider server, and service identification information of the service parameter are recorded.

Further, the service processing unit includes a key generation portion that generates share key generation information for creating a share key and transmits the generated share key generation information to the service provider server and generates the share key by receiving the share key generation information from the service provider server.

Meanwhile, an identity management method according to another embodiment of the present invention includes; actuating the identity management apparatus by browser' calling; receiving a service parameter in which a plurality of selectable protocol parameters are recorded, which are transmitted from a service provider server through the browser; selecting any one protocol parameter of the plurality of protocol parameters; performing a service protocol with the service provider server on the basis of the selected protocol parameter; receiving token information required to receive a service from service provider server from the service provider server; and transmitting the token information received from the service provider server to the browser.

In particular, the service parameter is any one of service parameters for site subscription, identification, update of identification information, update of a profile, log-out, and site secession for site subscription, identification, update of identification information, update of a profile, log-out, and site secession.

Further, in the selecting any one protocol parameter among the plurality of protocol parameters, the plurality of selectable protocol parameters are outputted to a user and any one protocol parameter is selected by receiving the resulting user selection.

Further, the identity management method further includes establishing a communication channel with the service provider server and validating the service provider server in accordance with server validation recorded in the service parameter.

Further, the protocol parameter is a protocol parameter relating to any one of an identification type, an encoding type, and a key size for encoding.

Further, the identification type includes at least one identification type of a password, a public key infrastructure (PKI), bio-information, and a two-factor identification type.

Further, the performing the service protocol with the service provider server on the basis of the selected protocol parameter includes encoding information required to perform the service protocol with the service provider server on the basis of the selected protocol parameter.

Further, the performing the service protocol with the service provider server on the basis of the selected protocol parameter includes: generating share key generation information for creating a share key and transmitting the generated share key generation information to the service provider server; and generating the share key by receiving the share key generation information from the service provider server.

Further, the identity management method further includes: generating identification information for performing user log-in in the service provider server and encoding the identification information for performing user log-in by using the created share key; and transmitting the encoded identification information for user log-in to the service provider server.

Further, in the generating identification information for performing user log-in in the service provider server, the identification information for performing user log-in is generated by using a pseudo-random function.

The present invention has the following effects.

A user is positioned at the center of all transactions and controls the circulation flow of user's personal information so as to reduce a damage caused due to the abuse of the personal information and more conveniently and safely manage the user's own personal information at the time of using the Internet.

In particular, the user can centrically control the circulation flow of the user's personal information with various security levels with respect to services such as identification, subscription, update of identification information, submission and update of a profile, log-out, secession, etc.

### BRIEF DESCRIPTION OF THE DRAWINGS

The drawings are described in order to more fully appreciate drawings cited in the detailed description of the present invention.

FIG. 1 is a block diagram for describing a system for user-centric identity management according to an embodiment of the present invention;

FIG. 2 is a diagram for describing, in more detail, an identity management apparatus of FIG. 1;

FIG. 3 is a diagram for describing a method for user-centric identity management according to an embodiment of the present invention;

FIG. 4 is a diagram showing an example of a subscription parameter which a service provider server transmits to an identity management apparatus for a subscription service; and

FIGS. 5 and 6 are flowcharts for describing a process in which an identity management apparatus performs a subscription service protocol with a service provider server.

### DETAILED DESCRIPTION OF THE PREFERRED EMBODIMENTS

Hereinafter, the present invention will be described in detail with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

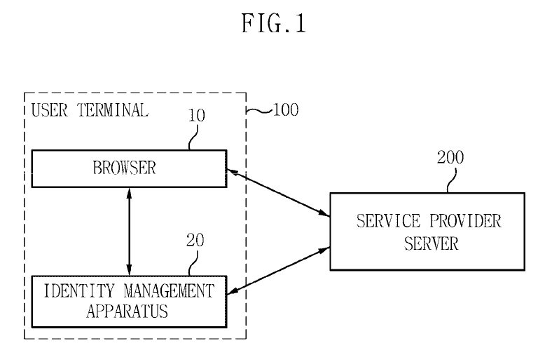

FIG. 1 is a block diagram for describing a user-centric identity management system according to an embodiment of the present invention.

The identity management system according to the embodiment of the present invention includes a user terminal 100 having an identity management apparatus 20 that interworks with a browser 10 and a service provider server 200.

The user-centric identity management system according to the embodiment of the present invention operates, for example, under a web environment and an implemented service environment has a client/server type.

The user terminal 100 provides information requested by the service provider server 200 to the service provider server 200 and therefore, is a subject that receives a predetermined Internet service from the service provider server 200. A user requests a service to the service provider server 200 through the browser 10 and receives the service from a service provider through the browser 10. For example, the user terminal 100 includes communication devices such as a computer, a mobile communication terminal, a PDA, etc. using a web browser such as the Internet explorer of the Microsoft or the Navigator of the Netscape.

The browser 10 requests the service to the service provider server 200, and receives a service parameter transmitted from the service provider server 200 and transmits the received parameter to the identity management apparatus 20 in accordance with the request of the service. The user should transmit token information requested by the service provider server 200 in order to receive the service through the browser 10. The browser receives service parameters corresponding to various services from the service provider server 200 and transfers the received service parameters to the identity management apparatus 20, in order to generate the token information. Herein, the service parameters have various types depending on identification, subscription of a site, update of identification information, submission and update of a basic profile, log-out, a site secession service, etc. In addition, a token represents a format which general ID management systems use to exchange security information or a user's identity.

The identity management apparatus 20 is called by the browser 10, and receives the service parameters from the browser 10 and provides the corresponding service to the user by performing a service protocol corresponding to the service provider server 200 and the corresponding service parameter. For example, when the identity management apparatus 20 receives an identification parameter from the browser 10, one or more identification types designated by the service provider server 200 and a service which can be received for each identification type are recorded in the identification parameter. Herein, as the identification type, a password, a public key infrastructure (PKI), bio-information, a two-factor identification type, etc. may be adopted and information, encoding types (i.e., AES, SEED, DESE, DES, RSA, etc.), an encoding key size, etc. which can be adopted depending on a security level may be differentiated even in the same identification type. Accordingly, the user can select an identification type by considering a service to be received and a terminal environment and prevent excessive personal information in comparison with the received service from being leaked or provided to the service provider server 200 by controlling the flow in which his/her own personal information is circulated at various security levels.

Further, the identity management apparatus 20 allows the service provider server 200 that requests the user's identity to share the user's identity, synchronizes identity information, and manages token information required to receive the service. In general, the identity is divided into a profile and a share identity. The profile generally is user information provided at the time of subscribing to a site and the share identity represents regulation and data for sharing information generated between the user and the service provider server. For example, the profile may be information used to uniquely differentiate an individual, which includes user information such as a nickname, a company address, a home address, a phone number, and a family, which is issued or registered in an organization such as a government or a company, an academic career, a hobby, a religion, a user identifier, etc.

All user's identities are shared by the service provider server 200 through the identity management apparatus 20.

According to the request for the service received from the browser 10, the service provider server 200 transmits the corresponding service parameter to the browser 10. For example, in case where the received message is a message requesting subscription, a service parameter for subscription is transmitted to the browser 10 and in case where the received message is a message for updating the identification information, a service parameter for updating the identification information is transmitted.

The service provider server 200 transmits the service parameter to the browser 10 and thereafter, performs a predetermined service protocol with the identity management apparatus 20. When the service protocol with the identity management apparatus 20 has been performed, the identity and the service provider server 200 transmits the corresponding token information to the identity management apparatus 20. Herein, the token information is used for the user to receive the corresponding service from the service provider server 200 through the browser 10.

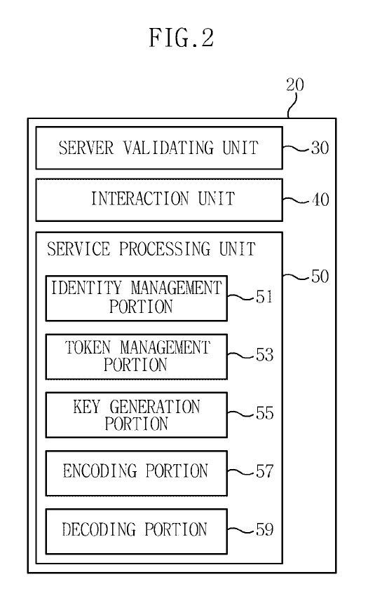

FIG. 2 is a diagram for describing, in more detail, an identity management apparatus of FIG. 1.

Referring to FIG. 2, the identity management apparatus 20 according to the embodiment of the present invention includes a server validating unit 30, an interaction unit 40, and a service processing unit 50.

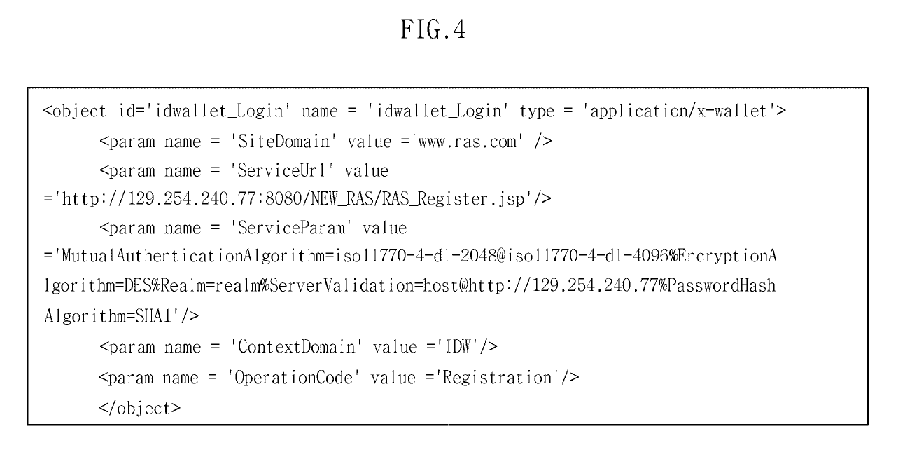

The server validating unit 30 establishes a communication channel with the service provider server 200 and validates the server by using a hypertext transfer protocol (HTTP) or a secure socket layer (SSL) by a server validation server (see FIG. 4) of the service parameter received through the browser 10. When the server validation is ‘host’, the server validating unit 30 performs a procedure of validating the server by using URL and has a type of “scheme://host:port”. When the server validation is ‘TLS-CERT’, an SSL channel is established and the server is validated. More specifically, the service provider server 200 is validated by acquiring a transport layer security (TLS) public key certificate by accessing ‘ServiceUrl’ of the service provider server 200 and verifying coincidence or not on the basis of a hash octet string of the public key certificate.

The interaction unit 40 outputs related data requiring user selection to the user and receives the resulting user selection at the time of performing a predetermined service protocol with the service provider server 200. For example, the interaction unit 40 a user ID to be generated in the service provider server 200 from the user, and outputs a plurality of identification types, encoding types, and encoding key sizes designated by the service provider server 200 to the user and receives the resulting user selection.

The service processing unit 50 performs a predetermined service protocol with the service provider server 200 by using the service parameter received from the service provider server 200. In addition, the service processing unit 50 acquires the token information from the service provider server 200 to allow the user to receive the service from the service provider server 200.

For this, the service processing unit 50 includes an identity management portion 51, a token management portion 53, a key generation portion 55, an encoding portion 57, and a decoding portion 59.

The identity management portion 51 allows the service provider server 200 that requests the identity to the user to share the user's identity and manages it.

The token management portion 53 manages the token information received form the service provider server 200 and transfers it to the browser 10.

The key generation portion 55 generates share key generation information for creating a share key and generates the share key by using the share key generation information received from the service provider server 200.

The encoding portion 57 encodes information required to perform the service protocol with the service provider server 200 on the basis of the encoding type recorded in the service parameter. For example, information encoded by the encoding portion 57 includes identification shared secret (SS) for log-in, a user profile, and information such as a session ID in case of log-out and secession. The shared secret (SS) for log-in may be a password constituted by a combination of at least one of numbers and characters.

The decoding portion 59 decodes the information required to perform the service protocol with the service provider server 200 on the basis of the encoding type recorded in the service parameter.

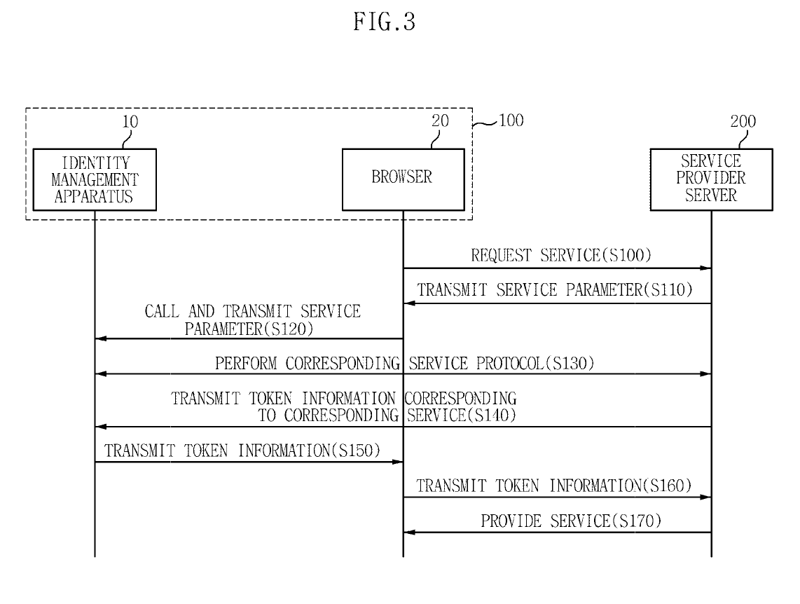

FIG. 3 is a diagram for describing a method for user-centric identity management according to an embodiment of the present invention.

A user requests a predetermined service to a service provider server 200 through a browser 10 (S100).

The service provider server 200 that receives the service request from a user terminal 100 transmits a service parameter corresponding to the corresponding service to the browser 10 of the user terminal 100 and request token information required to provide the service to the user terminal 100 (S110).

The browser 10 that receives the service parameter from the service provider server 200 calls an identity management apparatus 20 and actuates it, and transfers the received service parameter (S120).

The identity management apparatus 20 that receives the service parameter from the browser 10 performs a service protocol corresponding to the corresponding service parameter with the service provider server 200 by using the transferred service parameter (S130). Herein, the service parameter has different types depending on a service which the user wants to receive.

When the service protocol is completed between the identity management apparatus 20 and the service provider server 200, the service provider server 200 transmits the token information to the identity management apparatus 20 (S140). The browser 10 should provide the token information to the service provider server 200 by receiving the token information from the identity management apparatus 20 in order to receive the corresponding service from the service provider server 200.

Next, the identity management apparatus 20 allows the browser 10 to provide the token information to the service provider server 200 by transferring the token information received from the service provider server 200 to the browser 10 (S150).

The browser 10 that receives the token information at step 5150 transmits the token information to the service provider server 200 and requests the corresponding service to the service provider server 200.

Lastly, the service provider server 200 receives the token information from the browser 10 and validates the received token information, and thereafter, provides the corresponding service when a validation result is suitable (S170).

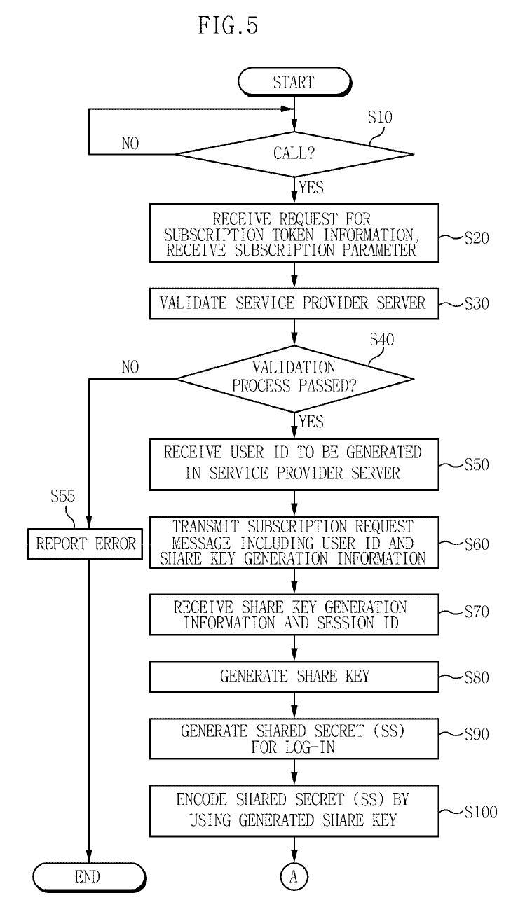

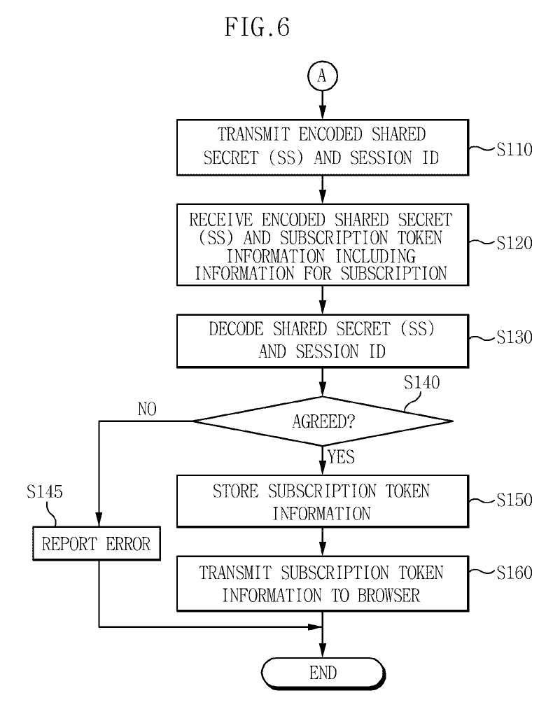

FIGS. 5 and 6 are flowcharts for, in more detail, describing a process in which an identity management apparatus performs a subscription service protocol with a service provider server. Herein, the subscription service is a function to subscribe to the service provider server by using the identity management apparatus. More specifically, the subscription service includes a function to generate a user account by using a user ID inputted by the user, a function to exchange a shared secret (SS) for automatic log-in, and a function to provide token information which can be used when the user logs in the service provider server.

Referring to FIGS. 5 and 6, first, the browser requests the subscription service to the service provider server and thus receives a request for token information (subscription token information) for subscription in addition to a service parameter for subscription (hereinafter, referred to as ‘subscription parameter’) from the service provider server. When the browser receives the request for the subscription token information in addition to the subscription parameter from the service provider server, the browser calls the identity management apparatus. In addition, the browser transfers data received from the service provider server to the identity management apparatus.

The identity management apparatus is actuated by browser's calling (S10). The actuated identity management apparatus receives the request for the subscription parameter and the subscription token information from the browser (S20).

The subscription parameter received through the browser has a type shown in FIG. 4. Referring to FIG. 4, ‘SiteDomain’ in the subscription parameter represents a domain name of the service provider server which is a subject providing the service and ‘SeviceUrl’ represents location identification information (i.e., URL) of the service provider server processing the subscription service. In addition, ‘Service Param’ represents the protocol parameter and ‘OperationCode’ represents that the corresponding service parameter is a parameter for providing the subscription service and depends on the kind of the corresponding service.

‘MutualAuthenticationAlgorithm’ among protocol parameters recorded in ‘ServiceParam’ of FIG. 4 is configured to select one protocol parameter of ‘iso1177-4-dl-2048’ and ‘iso1177-4-dl-2096’. The user can select one of a plurality of protocol parameters in other service protocols (i.e., update of identification information, secession, and a service protocol for log-out) in addition to the subscription parameter. Accordingly, the user can select an identification type by considering a service to be received and a terminal environment and prevent excessive personal information in comparison with the received service from being leaked or provided to the service provider server by controlling a flow in which his/her own personal information is circulated at various security levels.

Next, the identity management apparatus validates establishes the service provider server and a channel, and validates the server by using HTTP or SSL in accordance with ‘server validation’ recorded in the subscription parameter (S30). When the server validation is ‘host’, the server validating unit 30 performs a procedure of validating the server by using URL and has a type of “scheme://host:port”. When the server validation is ‘TLS-CERT’, an SSL channel is established and the server is validated. More specifically, a TLS public certificate is acquired and coincidence is verified by accessing ‘ServiceUrl’ of the service provider server on the basis of a hash octet string of the public key certificate (S40).

In case where the service provider server passes the validation procedure at step S40, the identity management apparatus receives a user ID to be generated in the service provider server from the user (S50). In addition, ‘share key generation information’ (i.e., sa=random[1,r-1], wa=ĝsa mod q) which is information for creating a share key is generated and transmitted to the service provider server with a subscription request message including the user ID (S60).

In case where the service provider server does not pass the validation procedure at step S40, the fact that the service provider server does not pass the predetermined validation procedure is notified to the user and the process is terminated (S45).

Meanwhile, the service provider server processes the subscription request message and the key generation information received from the identity management apparatus. The service provider server generates a user record by using the received user ID and stores the user ID in the corresponding user record. At this time, the service provider server verifies whether or not wa is smaller than q−1 and verifies whether or not the received user ID is duplicated. That is, by judging whether or not the same user ID as the received user ID is previously stored, in case where the same user ID exists, a user ID retransmission request message is returned to the identity management apparatus and in case where the same user ID does not exist, the received user ID is stored by generating the user record.

Further, the service provider server generates share key generation information (Pi=h(vs(algorithm)|vs(auth-domain)|vs(realm)|vs(id)), vs(s)=vi(length(s))|s, vi(i)=octet(i) for i<128, octet(0x80|(i>>7))|octet(i&127) for 128<=I<16384, Sb=random[1,r-1], Wb=((ĝ (pi) mod q)*wâ(H(octet(1))|octets(wa)))̂sb mod q) for creating the share key and transmits the information to the identity management apparatus with a session ID.

Next, the identity management apparatus receives the message transmitted from the service provider server. That is, the identity management apparatus receives the share key generation information and the session ID from the service provider server, and validates it and generates the share key. More specifically, the identity management apparatus verifies whether or not Wb is smaller than q−1 and generates the share key (Pi=h(vs(algorithm)|vs(auth-domain)|vs(realm)|vs(id)), vs(s)=vi(length(s))|s, vi(i)=octet(i) for i<128, octet(0x80|(i>>7))|octet(i&127) for 128<=I<16384, share key z=wb̂((sa+H(octet(2)|OCTETS(wa)|OCTETS(wb)))/(sa*H(octet(1)|wa)+(pi)) mod r) mod q) (S80).

Next, the identity management apparatus encodes the shared secret (SS) for log-in by using the corresponding share key (S100) and transmits the encoded shared key to the service provider server in addition to the session ID (S110). Herein, the identity management apparatus generates the shared secret (SS) for user log-in by using a pseudo-random function and encodes the shared secret (SS) for log-in according to an encoding type (i.e., DES) recorded in the subscription parameter received at step S20. In addition, a symmetric key uses and generates an initial bit of a share key z according to the size of the key.

In addition, the service provider server receives the encoded shared secret (SS) and the session ID from the identity management apparatus, and decodes the encoded shared secret (SS) and validates the session ID. More specifically, the service provider server generates the share key (z=(wa*ĝH(octet(2)|OCTETS(wa)|OCTETS(wb)))̂sb mod q) and decodes the shared secret (SS) for log-in according to the encoding type recorded in the subscription parameter transmitted to the identity management apparatus at step S20. At this time, the symmetric key uses and generates an initial bit of a share key z according to the size of the key. In addition, the service provider server stores the decoded shared secret (SS) in a record of the corresponding user mapped in the session ID.

Next, the service provider server encodes the shared secret (SS) and the session ID for log-in according to the encoding type recorded in the subscription parameter and thereafter, transmits them to the identity management apparatus in addition to token information (subscription token information) including information required for subscription.

Next, the identity management apparatus receives data from the service provider server and decodes the shared secret (SS) and the session ID for log-in according to the encoding type recorded in the subscription parameter (S130) and judges whether the shared secret (SS) and the session ID coincide with information which the identity management apparatus transmits (S140).

As a judgment result at step 5140, when the shared secret (SS) and the session ID coincide with the information, after the subscription token information is stored (S150), the stored subscription token information is transmitted to the browser (S160). Therefore, the browser transmits the received subscription token information to the service provider server and receives the service from the service provider server.

Meanwhile, as the judgment result at step S140, an error is reported to the user and the process is terminated (S145).

As described above, only a case in which a subscription service protocol among various service protocols which can be performed in the identity management system according to the present invention is performed will be described as an example. However, as described above, types of the service protocols performed according to the kind of the service parameter may be slightly different, but update of identification information, submission and update of a basic profile, log-out, a secession service excluding a subscription service are implemented as a type in which only information which is inter-transacted is changed by using the encoding type. For example, information such as new created SS information in case of update of identification information, profile information in case of submission or update of the profile, and the session ID in case of log-out and secession are encoded and transacted on the basis of the encoding type recorded in the service parameter.

According to the above description, even under an environment requiring comparatively high-level security, the user is positioned at the center of all transactions to control a circulation flow of his/her personal information. Accordingly, the user can reduce a damage caused due to abuse of the personal information at the time of using the Internet and can more conveniently and safely manage his/her personal information. In particular, the user can centrically control the circulation flow of the user's personal information using various security levels with respect to services such as identification, subscription, update of identification information, submission and update of a profile, log-out, secession, etc.

As described above, the optimal embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A user terminal for a user-centric identity management system, which is connected to a service provider server through a network, comprising:
a browser that requests a service to the service provider server and receives a service parameter in which a plurality of selectable protocol parameters corresponding to the service are recorded from the service provider server;
an interaction unit that selects any one protocol parameter among the plurality of protocol parameters by receiving the service parameter through the browser; and
a service processing unit that performs a service protocol with the service provider server on the basis of the protocol parameter selected through the interaction unit, and receives token information required to receive the service from the service provider server and transfers the token information to the browser.

2. The user terminal for a user-centric identity management system according to claim 1, wherein the service parameter is any one of service parameters for site subscription, identification, update of identification information, update of a profile, log-out, and site secession.

3. The user terminal for a user-centric identity management system according to claim 1, wherein the interaction unit outputs the plurality of selectable protocol parameters to a user and selects any one protocol parameter among the plurality protocol parameters by receiving the resulting user selection.

4. The user terminal for a user-centric identity management system according to claim 1, wherein the protocol parameter is a protocol parameter relating to any one of an identification type, an encoding type, and a key size for encoding.

5. The user terminal for a user-centric identity management system according to claim 4, wherein the identification type includes at least one identification type of a password, a public key infrastructure (PKI), bio-information, and a two-factor identification type.

6. The user terminal for a user-centric identity management system according to claim 1, wherein the service processing unit includes an encoding portion that encodes information required to perform the service protocol with the service provider server on the basis of the selected protocol parameter.

7. The user terminal for a user-centric identity management system according to claim 1, further comprising:
a server validation portion that establishes a communication channel with the service provider server in accordance with server validation recorded in the service parameter and validates the service provider server.

8. The user terminal for a user-centric identity management system according to claim 1, wherein in the service parameter, location identification information of the service provider server, a domain name of the service provider server, and service identification information of the service parameter are recorded.

9. The user terminal for a user-centric identity management system according to claim 1, wherein the service processing unit includes a key generation portion that generates share key generation information for creating a share key and transmits the generated share key generation information to the service provider server and generates the share key by receiving the share key generation information from the service provider server.

10. An identity management method of an identity management apparatus that interworks with a browser, comprising:
actuating the identity management apparatus by browser' calling;
receiving a service parameter in which a plurality of selectable protocol parameters are recorded, which are transmitted from a service provider server through the browser;
selecting any one protocol parameter of the plurality of protocol parameters;
performing a service protocol with the service provider server on the basis of the selected protocol parameter;
receiving token information required to receive a service from service provider server from the service provider server; and
transmitting the token information received from the service provider server to the browser.

11. The identity management method according to claim 10, wherein the service parameter is any one of service parameters for site subscription, identification, update of identification information, update of a profile, log-out, and site secession.

12. The identity management method according to claim 10, wherein in the selecting any one protocol parameter among the plurality of protocol parameters, the plurality of selectable protocol parameters are outputted to a user and any one protocol parameter is selected by receiving the resulting user selection.

13. The identity management method according to claim 10, further comprising:
establishing a communication channel with the service provider server and validating the service provider server in accordance with server validation recorded in the service parameter.

14. The identity management method according to claim 10, wherein the protocol parameter is a protocol parameter relating to any one of an identification type, an encoding type, and a key size for encoding.

15. The identity management method according to claim 14, wherein the identification type includes at least one identification type of a password, a public key infrastructure (PKI), bio-information, and a two-factor identification type.

16. The identity management method according to claim 10, wherein the performing the service protocol with the service provider server on the basis of the selected protocol parameter includes encoding information required to perform the service protocol with the service provider server on the basis of the selected protocol parameter.

17. The identity management method according to claim 10, wherein the performing the service protocol with the service provider server on the basis of the selected protocol parameter includes:
generating share key generation information for creating a share key and transmitting the generated share key generation information to the service provider server; and
generating the share key by receiving the share key generation information from the service provider server.

18. The identity management method according to claim 17, further comprising:
generating identification information for performing user log-in in the service provider server and encoding the identification information for performing user log-in by using the generated share key; and
transmitting the encoded identification information for performing user log-in to the service provider server.

19. The identity management method according to claim 18, wherein in the generating identification information for performing user log-in in the service provider server, the identification information for performing user log-in is generated by using a pseudo-random function.
